(19) United States
(12) Patent Application Publication
(10) Pub. No.: US 2009/0263297 A1
(43) Pub. Date: Oct. 22, 2009

(54) CATALYST AND METHOD OF MANUFACTURE

(75) Inventors: Dan Hancu, Clifton Park, NY (US); Donald Wayne Whisenhunt, JR., Niskayuna, NY (US); Benjamin Hale Winkler, Albany, NY (US); Benjamin Rue Wood, Niskayuna, NY (US); Hrishikesh Keshavan, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/474,873

(22) Filed: May 29, 2009

Related U.S. Application Data
(63) Continuation-in-part of application No. 12/173,492, filed on Jul. 15, 2008.
(60) Provisional application No. 60/994,448, filed on Sep. 19, 2007.

(51) Int. Cl. B01J 29/88; B01J 29/08; B01J 29/18; B01J 29/22; B01J 29/24; B01D 53/34

(52) U.S. Cl. 422/177; 502/60; 502/79; 502/78; 502/77; 502/74; 502/73

(57) ABSTRACT

Disclosed herein is a catalytic composition comprising a first catalyst composition portion that comprises a zeolite; and a second catalyst composition portion that comprises a catalytic metal disposed upon a porous inorganic substrate; the first catalyst composition portion and the second catalyst composition portion being in an intimate mixture.

### CROSS REFERENCE TO RELATED APPLICATIONS

This application is a continuation-in-part of U.S. patent application Ser. No. 12/173,192, filed 15 Jul. 2008 entitled “CATALYST AND METHOD OF MANUFACTURE” which claims the priority and benefit of U.S. Provisional Application No. 60/994,448, filed on 19 Sep. 2007, both of which are incorporated in their entirety herein by reference.

### TECHNICAL FIELD

The systems and techniques described include embodiments that relate to catalysts. They also include embodiments that relate to the making of catalysts and systems that may include catalysts.

### DISCUSSION OF RELATED ART

Exhaust streams generated by the combustion of fossil fuels, such as in furnaces, ovens, and engines, contain various potentially undesirable combustion products including nitrogen oxides (NOx), unburned hydrocarbons (HC), and carbon monoxide (CO). NOx, though thermodynamically unstable, may not spontaneously decompose in the absence of a catalyst. Exhaust streams may employ exhaust treatment devices to remove NOx from the exhaust stream.

Examples of exhaust treatment devices include: catalytic converters (e.g., three-way catalyst, oxidation catalysts, selective catalytic reduction (SCR) catalysts, and the like), evaporative emissions devices, scrubbing devices (e.g., hydrocarbon (HC), sulfur, and the like), particulate filters/traps, adsorbers/absorbers, plasma reactors (e.g., non-thermal plasma reactors and thermal plasma reactors), and the like. A three-way catalyst (TWC catalyst) in a catalytic converter may reduce NOx by using CO and residual hydrocarbon. TWC catalysts may be effective over a specific operating range of both lean and rich fuel/air conditions and within a specific operating temperature range.

Particulate catalyst compositions may enable optimization of the conversion of HC, CO, and NOx. The conversion rate may depend on the exhaust gas temperature. The catalytic converter may operate at an elevated catalyst temperature of about 300 degrees Celsius or higher. The time period between when the exhaust emissions begin (i.e., “cold start”), until the time when the substrate heats up to a light-off temperature, is the light-off time. Light-off temperature is the catalyst temperature at which fifty percent (50%) of the emissions from the engine convert as they pass through the catalyst.

The exhaust gases from the engine may heat the catalytic converter. This heating may help bring the catalyst to light-off temperature. The exhaust gases pass through the catalytic converter relatively unchanged until the light-off temperature is reached. In addition, the composition of the engine exhaust gas changes as the engine temperature increases from a cold start temperature to an operating temperature, and the TWC catalyst may work with the exhaust gas composition that is present at normal elevated engine operating temperatures.

Selective Catalytic Reduction (SCR) may include a noble metal system, base metal system, or zeolite system. The noble metal catalyst may operate in a temperature regime of from about 240 degrees Celsius to about 270 degrees Celsius, but may be inhibited by the presence of SO₂. The base metal catalysts may operate in a temperature range of from about 310 degrees Celsius to about 400 degrees Celsius, but may promote oxidation of SO₂ to SO₃. The zeolites can withstand temperatures up to 600 degrees Celsius and, when impregnated with a base metal may have a wide range of operating temperatures.

SCR systems with ammonia as a reductant may yield NOx reduction efficiencies of more than 80% in large natural gas fired turbine engines, and in lean burn diesel engines. However, the presence of ammonia may be undesirable, and there may be some ammonia slip due to imperfect distribution of reacting gases.

Selective Catalytic Reduction with hydrocarbons may reduce NOx emissions. NOx can be selectively reduced by some organic compounds (e.g. alkanes, olefins, alcohols) over several catalysts under excess O₂ conditions. The injection of diesel or methanol has been explored in heavy-duty stationary diesel engines to supplement the HCs in the exhaust stream. However, the conversion efficiency may be reduced outside the temperature range of 300 degrees Celsius to 400 degrees Celsius. In addition, this technique may have HC-slippage over the catalyst, transportation and on-site bulk storage of hydrocarbons, and possible atmospheric release of the HC. The partial oxidation of hydrocarbons may release CO, unburned HC, and particulates.

It may be desirable to have a catalyst that can effect emission reduction across a range of temperatures and operating conditions that differ from those currently available. It may also be desirable to have a catalyst that can effect NOx reduction using a reductant is different than the currently used reductants.

### BRIEF DESCRIPTION

In one embodiment of the system described herein, a catalyst system comprising a first catalyst composition and a second catalyst composition is provided. The first catalyst composition is a zeolite, and the second catalyst composition includes a catalytic metal disposed on a porous inorganic substrate. The first and second catalyst compositions are in an intimate mixture.

In a further aspect of such systems, the system includes an exhaust gas stream that flows over the surface of the intimate mixture. A reductant may be introduced into the gas stream upstream of the intimate mixture.

In yet another aspect of such systems, the system reduces the nitrogen oxide concentration in the exhaust gas stream.

### BRIEF DESCRIPTION OF DRAWING FIGURES

FIG. 1 is a schematic diagram depicting the furnace set-up of Example 1;

FIG. 2 is a bar graph that shows NOx conversion at various temperatures in the furnace configuration shown in FIG. 1;

FIG. 3(a) is a schematic diagram depicting a furnace set-up of Example 3;

FIG. 3(b) is a schematic diagram depicting the furnace set-up of Example 3;

FIG. 4 is a bar graph that shows NOx conversion at various temperatures in the furnace for the configurations of Example 3;

FIG. 5 shows graphs indicating the NOx conversion performance at various temperatures for four configurations discussed in Example 5; and

FIG. 6 shows graphs indicating the NO x conversion performance at various temperatures for four configurations discussed in Example 6.

### DETAILED DESCRIPTION

This systems and techniques described include embodiments that relate to catalysts and their use and manufacture. Other embodiments relate to articles that include catalysts and catalytic compositions that may chemically reduce NOx that is present in emissions generated during combustion, for example in furnaces, ovens, engines, and locomotives.

In one embodiment, the catalytic composition may include a first catalyst composition portion and a second catalyst composition portion that are mixed together. The first catalyst composition portion and the second catalyst composition portion may be intimately mixed together. The mixed catalytic composition may reduce the NOx present in emissions generated during combustion when in contact therewith. The mixed catalytic composition may reduce a larger amount of NOx in an emissions stream relative to a similar catalytic composition that is not intimately mixed together. The term “intimately” or “intimate” as it relates to the mixing of the first catalyst composition portion and the second catalyst composition portion is intended to mean that a portion of the respective compositions are in particulate form and the particulates are in physical contact with one another.

The first catalyst composition portion includes a zeolite while the second catalyst composition portion includes a catalytic metal disposed upon a porous substrate. The porous substrate includes an inorganic material that can be a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or the like, or a combination including at least one of the foregoing inorganic materials. When the catalytic composition is employed to reduce NOx generated in emissions from furnaces, ovens, locomotives and engines, a variety of hydrocarbons can be effectively used as a reductant. In an exemplary embodiment, diesel can be used as a reductant. The catalytic composition can reduce NOx while using higher hydrocarbons having from about 5 to about 9 carbon atoms per molecule as a reductant. The catalyst advantageously functions across a variety of temperature ranges. Suitable temperature ranges may include temperatures of greater than about 325 degrees Celsius. Other temperatures ranges may include those up to about 400 degrees Celsius.

The first catalyst composition portion may include a zeolite. In one embodiment, the zeolite is metal free, i.e., the zeolite contains no metal ions and is not doped with a metal. The zeolites may be naturally occurring or synthetic. Examples of suitable zeolites are zeolite Y, zeolite beta, ferrierite, mordenite, ZSM-5, or the like, or a combination including at least one of the foregoing zeolites. In one embodiment, the first catalyst composition portion consists essentially of ferrierite.

An exemplary zeolite is a ferrierite having a silicon to aluminum ratio of about 10 to about 30. In one embodiment, the ferrierite has a silicon to aluminum ratio of about 12 to about 15, about 15 to about 17, about 17 to about 20, about 20 to about 23, about 23 to about 25, or greater than about 25.

Examples of commercially available zeolites that may be used in the first catalyst composition portion are marketed under the following trademarks: CBV100, CBV300, CBV400, CBV500, CBV600, CBV712, CBV720, CBV760, CBV780, CBV901, CP814E, CP814C, CP811C-300, CP914, CP914C, CBV2314, CBV3024E, CBV5524G, CBV8014, CBV28014, CBV10A, CBV21A, CBV90A, or the like, or a combination including at least one of the foregoing commercially available zeolites.

An average catalytic composition particle size is less than about 100 nanometers. In one embodiment, the average catalytic composition particle size is in a range of from about 0.1 nanometers to about 1 nanometer, from about 1 nanometer to about 5 nanometers, from about 5 nanometers to about 15 nanometers, from about 15 nanometers to about 25 nanometers, from about 25 nanometers to about 50 nanometers, or greater than about 50 nanometers.

The zeolite particles are in the form of extrudates and generally have an average particle size up to about 1.60 millimeters. In one embodiment, the zeolite particles have an average particle size of about 0.001 millimeters to about 0.1 millimeters, about 0.1 millimeters to about 0.5 millimeters, about 0.5 millimeters to about 0.8 millimeters, about 0.8 millimeters to about 1.1 millimeters, or greater than about 1.1 millimeters. In an exemplary embodiment, the zeolite particles have an average particle size of about 0.001 millimeter.

The zeolite particles may have a surface area of up to about 600 square meters per gram (m²/gm). In one embodiment, the zeolite particles may have a surface area in a range of from about 50 m²/gm to about 100 m²/gm, from about 100/gm to about 200/gm, from about 200/gm to about 300/gm, from about 300/gm to about 400 m²/gm, from about 400 m²/gm to about 500 m²/gm, or greater than about 500 m²/gm.

The first catalyst composition portion may be present in an amount of up to about 80 wt %, based upon the total weight of the catalytic composition. In one embodiment, the first catalyst composition portion may be present in an amount in a range of from about 20 wt % to about 30 wt %, from about 30 wt % to about 40 wt %, from about 40 wt % to about 50 wt %, from about 50 wt % to about 60 wt %, from about 60 wt % to about 70 wt %, or greater than about 70 wt %, based upon the total weight of the catalytic composition.

As noted above, the second catalyst composition portion includes a metal disposed upon a porous substrate. The porous substrate is an inorganic material that can be a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbides, or the like, or a combination including at least one of the foregoing inorganic materials. In one embodiment, the porous substrate consists essentially of a metal oxide or an inorganic oxide.

Examples of suitable inorganic oxides include silica (SiO₂), alumina (Al₂O₃), titania (TiO₂), zirconia (ZrO₂), yttria (Y₂O₃), ceria (CeO₂), manganese oxide (MnO₂), zinc oxide (ZnO), iron oxides (e.g., FeO, β-Fe₂O₃, γ-Fe₂O₃, ε-Fe₂O₃, Fe₃O₄, or the like), calcium oxide (CaO), manganese dioxide (MnO₂ and Mn₃O₄), or combinations including at least one of the foregoing inorganic oxides. Examples of inorganic carbides include silicon carbide (SiC), titanium carbide (TiC), tantalum carbide (TaC), tungsten carbide (WC), hafnium carbide (HfC), or the like, or a combination including at least one of the foregoing carbides. Examples of suitable nitrides include silicon nitrides (Si₃N₄), titanium nitride (TiN), or the like, or a combination including at least one of the foregoing. Examples of suitable borides are lanthanum boride (LaB₆), chromium borides (CrB and CrB₂), molybdenum borides (MoB₂, Mo₂B₅ and MoB), tungsten boride (W₂B₅), or the like, or combinations including at least one of the foregoing borides. In one embodiment, the porous substrate consists essentially of alumina.

In another embodiment, the porous substrate includes one or more stabilizers, which may be added to the primary substrate. For example, in various embodiments, a substrate comprising predominantly alumina has smaller amounts of yttria, zirconia, or ceria added to it.

The porous substrate may have a surface area of up to about 2,000 square meters per gram (m²/gm). In one embodiment, the porous substrate may have a surface area in a range of from about 20 m²/gm to about 100 m²/gm, from about 100/gm to about 200/gm, from about 200/gm to about 400/gm, from about 400/gm to about 600 m²/gm, from about 600 m²/gm to about 800 m²/gm, from about 800 m²/gm to about 1,000 m²/gm, from about 1,000 m²/gm to about 1,200 m²/gm, from about 1,200 m²/gm to about 1,600 m²/gm, or greater than about 1,600 m²/gm.

The porous substrate may be in the form of particles. The particles may be agglomerates, a sintered mass, a surface coating on a support, or the like. The porous substrate may have an average particle size of up to about 4 millimeters. In one embodiment, the porous inorganic materials may have an average particle in a range of from about 5 micrometers to about 50 micrometers, from about 50 micrometers to about 100 micrometers, from about 100 micrometers to about 500 micrometers, from about 500 micrometers to about 1 millimeter, from about 1 millimeter to about 2 millimeters, from about 2 millimeters to about 3 millimeters, or greater than about 3 millimeters. In an exemplary embodiment, the porous substrate has an average particle size of about 40 micrometers.

The catalytic metal may include alkali metals, alkaline earth metals, transition metals and main group metals. Examples of suitable catalytic metals are silver, platinum, gold, palladium, iron, nickel, cobalt, gallium, indium, ruthenium, rhodium, osmium, iridium, or the like, or a combination including at least one of the foregoing metals. In one embodiment, the catalytic metal consists essentially of silver.

The average catalytic metal particle size may be up to about 50 nanometers. In one embodiment, the average catalytic metal particle size is about 1 nanometer to about 5 nanometers, about 5 to about 10 nanometers, about 10 to about 20 nanometers, about 20 nanometers to about 30 nanometers, about 30 nanometers to about 40 nanometers, or greater than or equal to about 40 nanometers.

The catalytic metals may be present in the second catalyst composition portion in an amount up to about 50 mole percent (mol %). In one embodiment, the catalytic metals are present in the second catalyst composition portion in an amount in a range of from about 0.025 mol % to about 1 mol %, from about 1 mol % to about 5 mol %, from about 5 mol % to about 10 mol %, from about 10 mol % to about 15 mol %, from about 15 mol % to about 20 mol %, from about 20 mol % to about 30 mol %, from about 30 mol % to about 40 mol %, or greater than or equal to about 40 mol %. One exemplary amount of catalytic metal in the second catalyst composition portion is about 1.5 mol %. One exemplary amount of catalytic metal in the second catalyst composition portion is about 5 mol %.

The second catalyst composition portion may be used in an amount of up to about 90 wt %, based upon the total weight of the catalytic composition. In one embodiment, the second catalyst composition portion may be used in an amount in a range of from about 20 wt %, to about 30 wt %, from about 30 wt %, to about 40 wt %, from about 40 wt %, to about 50 wt %, from about 50 wt %, to about 60 wt %, from about 60 wt %, to about 70 wt %, from about 70 wt %, to about 80 wt %, or greater than about 80 wt %, based upon the total weight of the catalytic composition.

In one embodiment, a suitable solvent, a catalytic metal salt and a porous substrate are mixed together in a reaction vessel to produce the second catalyst composition portion. The catalytic metal salt may impregnate pores of the porous substrate by incipient wetness impregnation. The porous substrate may be filtered, washed, dried and calcined to yield the second catalyst composition portion such that the catalytic metal is disposed on a surface of the porous substrate. During the calcination process, the metal salt may reduce to a catalytic metal.

The first catalyst composition portion and the second catalyst composition portion may intimately mix to form the catalytic composition. A synergy may exist between the first catalyst composition portion and the second catalyst composition portion, which may affect the reduction reaction of NOx to nitrogen when compared with other comparative catalyst. The first catalyst composition may facilitate the conversion of long chain hydrocarbons (C₅ to C₉) into short chain hydrocarbons (C₁ to C₄). The short chain hydrocarbons may affect reduction efficiency.

In a method of using the composition, the composition is disposed in the exhaust stream of an internal combustion engine. The internal combustion engine may be part of a variety of mobile or fixed assets, for example an automobile, locomotive, or power generator. Because different engines have different combustion characteristics the exhaust stream components differ from one system to another. Such differences may include variations in NOx levels, sulfur presence, and the presence or quantity of other species of reaction product. Changes in the operating parameters of the engine may also alter the exhaust flow characteristics. Examples of differing operating parameters may include temperature and flow rate. The catalyst may be used to reduce NOx to nitrogen and oxygen at a desirable rate and at a desirable temperature appropriate for the given system and operating parameters. The composition may be disposed in the exhaust gas path either in powdered form, in the form of an extruded monolith, or as a washcoated substrate. Various techniques for creating such powder beds, extrudates, or coated substrates are know in the art, and may be applied as appropriate for the desired composition and catalyst form.

During operation, the composition can convert the NOx present in an exhaust stream by about 90 weight percent. In one embodiment, the composition can convert the NOx present in an exhaust stream in an amount in a range of from about 10 weight percent to about 20 weight percent, from about 20 weight percent to about 30 weight percent, from about 30 weight percent to about 40 weight percent, from about 40 weight percent to about 50 weight percent, from about 50 weight percent to about 60 weight percent, from about 60 weight percent to about 70 weight percent, or greater than or equal to about 70 weight percent.

The following examples illustrate methods and embodiments in accordance with exemplary embodiments, and as such should not be construed as imposing limitations upon the claims. Unless specified otherwise, all components are commercially available from common chemical suppliers such as Alpha Aesar, Inc. (Ward Hill, Mass.), Spectrum Chemical Mfg. Corp. (Gardena, Calif.), and the like.

### EXAMPLES

### Example 1

The composition is manufactured by mixing a first catalyst composition portion including ferrierite with a second catalyst composition portion including 2 wt % silver disposed on an alumina porous substrate. The second catalyst composition portion is mixed with the first catalyst composition portion in a weight ratio of 4:1.

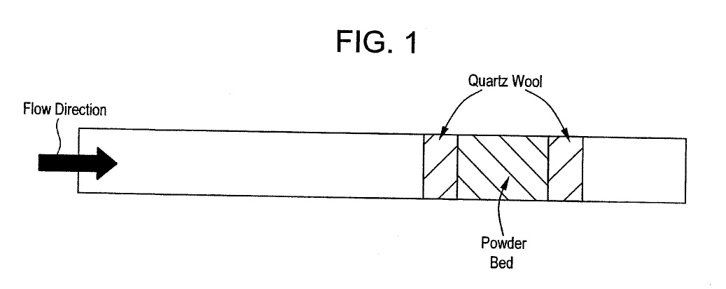

To determine the NOx reducing capabilities of the composition, it is placed in a furnace between two plugs of quartz wool as shown in FIG. 1.

### Example 2

A simulated exhaust stream is discharged into a furnace containing the composition as described in Example 1. The flow of the simulated exhaust stream through the furnace is 3 standard liters per minute. In various tests, the simulated exhaust stream contained nitric oxide in amounts of 475, 610 and 690 parts per million and carbon monoxide in amounts of 250 parts per million. The carbon to nitrogen ratio is set at 6:1. The hydrogen content is 0 parts per million. The water content is set at 7 wt %. The sulfur dioxide and carbon dioxide content is each 0 parts per million. The temperatures in the furnace during the respective experiments are 275, 375 and 430 degrees Celsius. The WSSV (weight specific space velocity) is 674 liters per gram per hour (L/g/hr).

During the flow of the simulated exhaust stream through the furnace a reductant is introduced into the furnace. The reductant included a 1:1 weight mixture of a C8 blend and a C2-C3 blend. The C8 blend included 64 wt % trimethylpentane, 29 wt % toluene and 7 wt % octane. The C2-C3 blend includes 54 wt % ethylene and 46 wt % propylene.

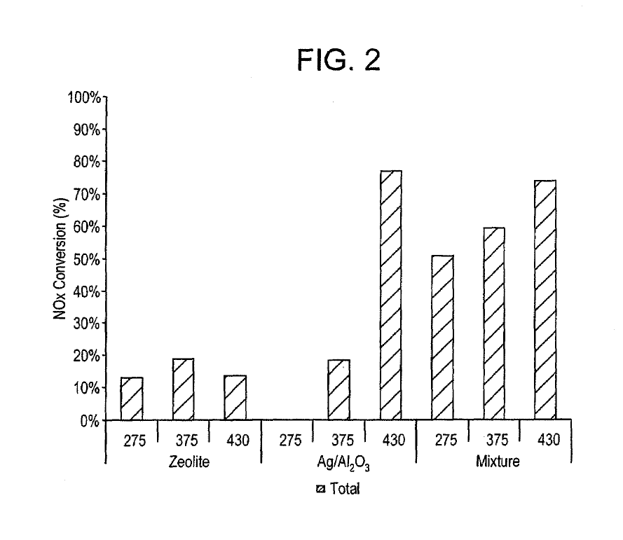

The catalytic composition is tested against two comparative compositions. The first comparative composition contained just the first catalyst composition portion (i.e., just the ferrierite), while the second comparative composition contained just the second catalyst composition portions (i.e., just the silver disposed upon porous alumina). The results for the composition and the two comparative compositions are shown in FIG. 2. FIG. 2 is a bar graph that shows NOx conversion at various temperatures in the furnace.

From the results it can be seen that the composition including the mixture of the first catalyst composition portion and the second catalyst composition portion is superior to either the first catalyst composition portion or the second catalyst composition portion. At the respective furnace temperatures of 275, 375 or 430 degrees Celsius, the composition converts an amount of greater than or equal to about 50% of the NOx contained in the simulated exhaust stream. At temperatures of 275 or 375 degrees Celsius the first catalyst composition portion or the second catalyst composition portion showed an ability to convert less than 20 wt % of the NOx present in the simulated exhaust stream. Only at 430 degrees Celsius, did the second catalyst composition portion show an ability to convert about 75 wt % of the NOx present in the simulated exhaust stream.

These results demonstrate the synergistic capabilities of the first catalyst composition portion and the second catalyst composition portion to reduce NOx present in an exhaust stream more effectively when mixed than when separate. This synergy is especially apparent at lower temperatures, such as the lower tested temperatures of 275 to 375 degrees Celsius.

### Example 3

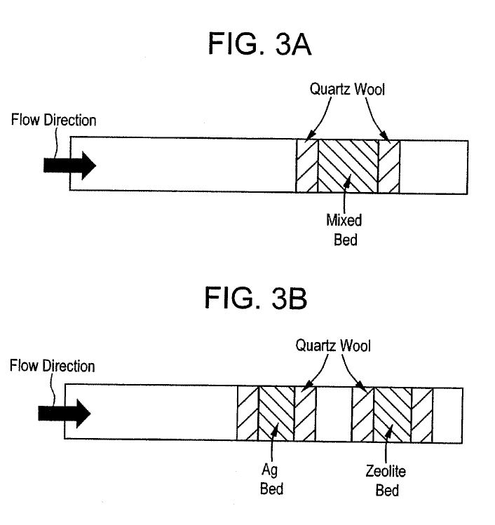

This example compares the ability to chemically reduce NOx between a first composition (Sample X) in which the first and second catalyst composition portions are intimately mixed together and a second material (Sample Y) in which the first and second catalyst composition portions are not mixed. The configuration of the furnace is shown in FIG. 3(a) and FIG. 3(b), respectively.

As shown in FIG. 3(a), Sample X is tested by placing a single bed containing the composition between two plugs of quartz wool. FIG. 3(b) shows the first catalyst composition portion and the second catalyst composition portion being placed in a dual bed configuration with each catalyst composition disposed between two plugs of quartz wool. The ferrierite (i.e., first catalyst composition portion) is placed downstream of the silver disposed on the alumina (i.e., the second catalyst composition portion). The remaining test conditions are the same as detailed in the Example 1.

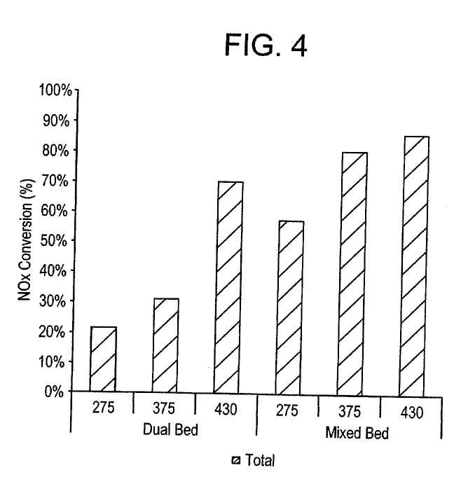

The results are shown in FIG. 4. as a bar graph that shows NOx conversion at the different temperatures for the system of FIG. 3(a) in intimate mixture form (the mixed, single bed configuration) and the system of FIG. 3(b) (the dual bed configuration). From FIG. 4, it may be seen that at all the tested temperatures and operating regimes, the composition displayed a superior NOx conversion capability when used in a mixed bed configuration.

### Example 4

This example demonstrates the NOx reducing capabilities of the catalytic composition. The example also demonstrates the NOx reducing capabilities of the catalytic composition when the first catalyst composition portion and the second catalyst composition portion are used in different weight ratios. The reductants selected for Example 3 are octane, Moctane (which includes 5 wt % of 2,4-dimethylhexane, 3 wt % of 3,4-dimethylhexane, 54 wt % of 2,2,4-trimethylpentane, 10 wt % octane and 29 wt % toluene), C₁-C₃, which includes methane, ethylene and propylene in amounts of 5500 ppm, 30,900 ppm and 27,500 ppm respectively. A Moctane/C₁-C₃ blend is the reductant. The weight ratio of Moctane to the C₁-C₃ is 1:1 based on the carbon present in the exhaust stream.

A simulated exhaust stream having a carbon to nitrogen ratio of 8 is used to determine NOx reduction in the furnace. The respective catalysts are inserted into the furnace in amounts of 25-36 grams. The nitrogen oxide content in the simulated exhaust gas stream is 600 ppm. The sulfur dioxide content is 1 ppm. The water content is 7 weight percent and the oxygen content is 13 weight percent with the balance being nitrogen. The WSSV (weight specific space velocity) for this example was 67-96 L/g/hr. The results are shown in the Table 3 below.

From Table 3, it can be seen that the catalytic composition containing the first catalyst composition portion (ferrierite) and the second catalyst composition portion (2 wt % silver on alumina) in a ratio of 1:4 produces superior NOx conversion results at all temperatures when C₁-C₃ and a Moctane/C₁-C₃ blend is the reductant.

TABLE 3

| | Reductant | | | | | |
|---|---|---|---|---|---|---|
| | Octane | | | Moctane | | |
| | Temperature (° C.) | | | | | |
| Catalyst Composition | 275 | 325 | 425 | 275 | 325 | 425 |
| 2%Ag/Al₂O₃ | 10 | 95 | 60 | 11 | 43 | 83 |
| Ferrierite | 2 | 4 | 12 | 2 | 4 | 10 |
| 2%Ag/Al₂O₃ followed by Ferrierite | 15 | 95 | 41 | 1 | 10 | 30 |
| (dual bed) | | | | | | |
| Ferrierite followed by 2%Ag/Al₂O₃ | 11 | 95 | 60 | 1 | 15 | 35 |
| (dual bed) | | | | | | |
| Mixed 2%Ag/Al₂O₃ and Ferrierite | 0 | 21 | 51 | 0 | 10 | 21 |
| (weight ratio 1:4) | | | | | | |
| Mixed 2%Ag/Al₂O₃ and Ferrierite | 0 | 52 | 60 | 0 | 18 | 43 |
| (weight ratio 2:3) | | | | | | |
| Mixed 2%Ag/Al₂O₃ and Ferrierite | 0 | 95 | 70 | 0 | 29 | 64 |
| (weight ratio 1:1) | | | | | | |
| Mixed 2%Ag/Al₂O₃ and Ferrierite | 0 | 90 | 65 | 0 | 28 | 63 |
| (weight ratio 3:2) | | | | | | |
| Mixed 2%Ag/Al₂O₃ and Ferrierite | 20 | 90 | 74 | 5 | 45 | 78 |
| (weight ratio 4:1) | | | | | | |
| Al₂O₃ | 2 | 5 | 20 | 1 | 2 | 3 |
| | Reductant | | | | | |
| | C1-C3 | | | Moctane/C1-C3 | | |
| | Temperature (° C.) | | | | | |
| Catalyst Composition | 275 | 325 | 425 | 275 | 325 | 425 |
| 2%Ag/Al₂O₃ | 2 | 10 | 29 | 11 | 20 | 50 |
| Ferrierite | 28 | 13 | 5 | 13 | 12 | 11 |
| 2%Ag/Al₂O₃ followed by Ferrierite | 33 | 45 | 46 | 22 | 38 | 50 |
| (dual bed) | | | | | | |
| Ferrierite followed by 2%Ag/Al₂O₃ | 14 | 39 | 48 | 13 | 31 | 47 |
| (dual bed) | | | | | | |
| Mixed 2%Ag/Al₂O₃ and Ferrierite | 15 | 38 | 45 | 20 | 33 | 40 |
| (weight ratio 1:4) | | | | | | |
| Mixed 2%Ag/Al₂O₃ and Ferrierite | 28 | 70 | 70 | 28 | 48 | 53 |
| (weight ratio 2:3) | | | | | | |
| Mixed 2%Ag/Al₂O₃ and Ferrierite | 44 | 88 | 82 | 31 | 65 | 65 |
| (weight ratio 1:1) | | | | | | |
| Mixed 2%Ag/Al₂O₃ and Ferrierite | 43 | 83 | 78 | 28 | 58 | 60 |
| (weight ratio 3:2) | | | | | | |
| Mixed 2%Ag/Al₂O₃ and Ferrierite | 75 | 80 | 75 | 48 | 61 | 65 |
| (weight ratio 4:1) | | | | | | |
| Al₂O₃ | 1 | 2 | 4 | 1 | 2 | 4 |

From the above experiments, the catalytic composition can convert up to 90 weight percent of the NOx present in an exhaust stream.

### Example 5

A further exemplary test was performed with four catalytic configurations. The first configuration 110 has a dual bed configuration (as shown in FIG. 3(b) with a first catalytic material being a copper-based zeolite in a bed disposed downstream of a second catalytic material containing a metal disposed upon a supporting substrate, specifically, silver on a templated alumina substrate. The second configuration 120 is identical but substitutes an iron-based zeolite for the copper-based zeolite in the first configuration. In both configurations, the ratio of the second catalytic material to the first by mass is 2:1. The third configuration 130 uses a single, mixed bed as shown in FIG. 3(a) with mixture of the first and second catalytic materials. The first catalytic material used in this configuration is a zeolite that is intimately mixed with a silver catalyst in a 1:16 mass ratio. The fourth configuration 140 uses a single bed of silver over templated alumina as the only catalytic material, configured as shown in FIG. 3(a).

The four configurations were exposed to simulated exhaust streams containing 300 ppm NO, 7% H₂O by mass, 9% O₂ by mass, 0 ppm SO₂ and 0 ppm CO. Tests were run for 1 hours at each configuration for exhaust stream temperatures of 300 Celsius, 350 Celsius, 400 Celsius, and 450 Celsius.

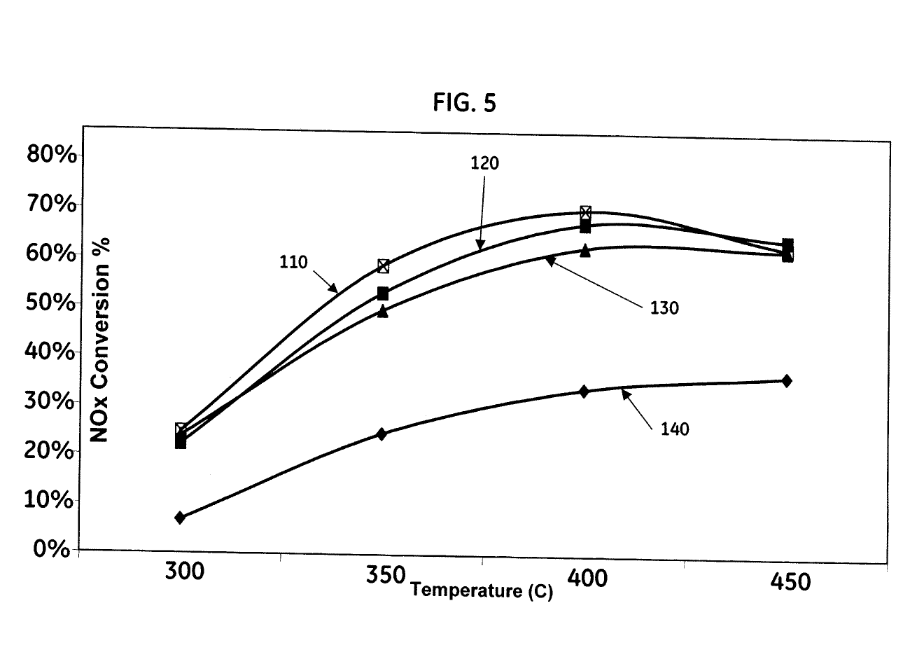

Reductant in the form of 1500 ppm of C₁ ultra-low Sulfur Diesel (ULSD) was added to the stream. Results for these exemplary test conditions are shown in FIG. 5. Although separate beds of the first and second catalytic materials performed slightly better at interim temperature ranges, it can be seen that at low temperature (i.e., startup), and at high temperature (i.e., operating conditions), the performance of the mixed bed in the third configuration was comparable to that of the dual beds of the first and second configurations. All other configurations were superior to the fourth configuration at NOx reduction at all tested temperatures.

In addition to the NOx reduction illustrated, secondary emissions of NH₃, HCN, N₂O and formaldehyde were also favorably reduced by the use of the mixed bed (third catalyst configuration) compared to the others. In particular, NH₃ and N₂O reduction by the mixed bed was superior or comparable in all tested conditions. HCN and formaldehyde emissions were comparable at higher operating temperatures as well as being superior at lower operating temperatures.

### Example 6

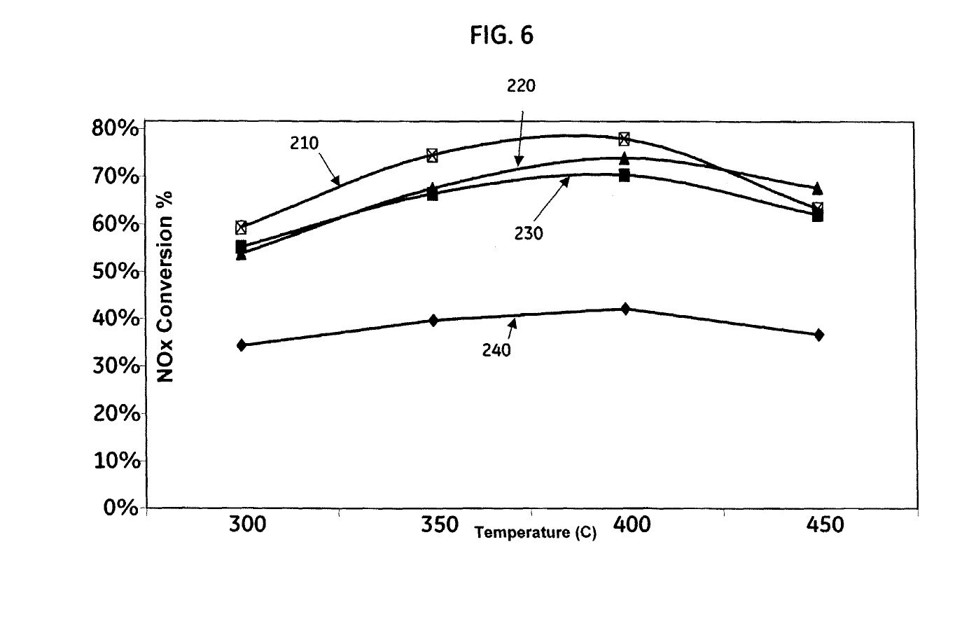

In another exemplary test, the same four configurations of Example 5 were tested under identical test conditions, but with an additional reductant added to the simulated exhaust stream: 1000 ppm of H₂. Results are shown for the first configuration 210, second configuration 220, third configuration 230 and fourth configuration 240 under these operating conditions. As can be seen from the results (shown in FIG. 6), the single, mixed bed configuration was comparable over most of the operating range to the NOx reduction results found in the dual bed configurations.

As a matter of definition, the term “diesel” refers to the distillate commonly available to operate in a diesel engine. While those of skill in the art will recognize that diesel fuel may vary in its precise mixture, that the term diesel encompasses all such varieties in mixture commonly available. This may include diesel fuel derived from a variety of sources, including for example, bio-diesel and petro-diesel. Ultra-low Sulfur Diesel refers to specific blends of diesel fuel commonly used in automotive engines that have very low sulfur levels. Similarly, the term “gasoline” is used to refer to any of the blends of distillate commonly available to operate in a gasoline engine.

While the systems and techniques herein have been described with reference to exemplary embodiments, it will be understood by those skilled in the art that various changes may be made and equivalents may be substituted for elements thereof without departing from their essential scope. In addition, many modifications may be made to adapt a particular situation or material to the teachings of a given embodiment without departing from the essential scope thereof. Therefore, it is intended that these systems and techniques are not limited to the particular embodiments disclosed as the best mode contemplated for carrying them out.

The various embodiments described herein may be examples of catalytic compositions and systems using such compositions and techniques for manufacturing these embodiments. Any given embodiment may provide one or more of the advantages recited, but need not provide all objects or advantages recited for any other embodiment. Those skilled in the art will recognize that the systems and techniques described herein may be embodied or carried out in a manner that achieves or optimizes one advantage or group of advantages as taught herein without necessarily achieving other objects or advantages as may be taught or suggested herein.

This written description may enable those of ordinary skill in the art to make and use embodiments having alternative elements that likewise correspond to the elements recited herein. While only certain features and embodiments have been illustrated and described herein, many modifications and changes may occur to one of ordinary skill in the relevant art. Thus, it is intended that the scope of the invention disclosed should not be limited by the particular disclosed embodiments described above, but should be determined only by a fair reading of the claims that follow.

What is claimed is:

1. A catalyst system comprising:
a first catalyst composition that comprises a zeolite; and
a second catalyst composition that comprises a catalytic metal disposed on a surface of a porous inorganic substrate,
wherein the first catalyst composition and the second catalyst composition form an intimate mixture.

2. The system as defined in claim 1, wherein the zeolite is zeolite Y, zeolite beta, mordenite, ZSM-5, or a combination comprising at least two of the foregoing.

3. The system as defined in claim 1, wherein the zeolite is ferrierite.

4. The system as defined in claim 3, wherein the ferrierite has a silicon to aluminum weight ratio in a range of from about 10 to about 30.

5. The system as defined in claim 3, wherein the ferrierite has a surface area in a range of from about 200 m²/gm to about 500 m²/gm.

6. The system as defined in claim 1, wherein the first catalyst composition is present in an amount in a range of from about 1 to about 80 weight percent, based upon the total weight of the first catalytic composition and the second catalytic composition.

7. The system as defined in claim 6, wherein the first catalyst is present in an amount in a range from about 3.5 to about 8 weight percent, based upon the total weight of the first catalytic composition and the second catalytic composition.

8. The system as defined in claim 1, wherein the catalytic metal is gold, palladium, cobalt, nickel, iron, copper, or a combination comprising at least one of the foregoing metals.

9. The system as defined in claim 1, wherein the catalytic metal is silver.

10. The system as defined in claim 1, wherein the catalytic metal is present in the second catalyst composition in an amount in a range of from about 0.025 mole percent to about 50 mole percent.

11. The system as defined in claim 1, wherein the porous inorganic substrate comprises an inorganic oxide, inorganic carbide, inorganic nitride, inorganic boride, inorganic oxycarbide, inorganic oxynitride, or a combination comprising at least one of the foregoing.

12. The system as defined in claim 11, wherein the porous inorganic substrate is a metal oxide, a metal carbide, a metal nitride, a metal boride, a metal oxycarbide, a metal oxynitride, or a combination comprising at least one of the foregoing.

13. The system as defined in claim 1, wherein the porous inorganic substrate comprises one member from the group consisting of silica, alumina, titania, zirconia, yttria, ceria, manganese oxide, zinc oxide, iron oxide, calcium oxide, manganese dioxide, silicon carbide, titanium carbide, tantalum carbide, tungsten carbide, hafnium carbide, silicon nitrides, titanium nitride, lanthanum boride, chromium borides, molybdenum borides, tungsten boride, and a combination comprising at least two of the foregoing porous inorganic substrates.

14. The system as defined in claim 1, wherein the porous inorganic substrate comprises alumina and at least one member of the group consisting of yttria, zirconia and ceria.

15. The system as defined in claim 1, wherein the porous inorganic substrate is alumina.

16. The system as defined in claim 1, wherein the system comprises a monolith disposed within the exhaust stream of a combustion engine.

17. The system as defined in claim 1, wherein the system comprises a substrate that is washcoated with the first catalyst composition and the second catalyst composition.

18. The system as defined in claim 1 further comprising an exhaust gas stream that flows over the intimate mixture and a reductant that is introduced into the exhaust gas stream upstream of the intimate mixture,
wherein the system reduces the nitrogen oxide concentration in the exhaust gas stream in contact therewith at a temperature in a range of from about 200 to about 500 degrees Celsius.

19. The system defined in claim 15, wherein the reductant is a hydrocarbon.

20. The system defined in claim 19, wherein the reductant is one or more of diesel, ultra-low sulfur diesel, ethanol, gasoline, octane, and Moctane.

21. The system defined in claim 20, wherein the reductant is a hydrocarbon of chain length 3 or less.

22. The system defined in claim 21, wherein the reductant is one or more of methane, ethylene, and propylene.

23. The system defined in claim 19, wherein the reductant is an oxygenated hydrocarbon.

24. The system defined in claim New 23, wherein the reductant is ethanol.

25. The system defined in claim 19, wherein the reductant is diesel.

26. The system defined in claim 16, wherein hydrogen is introduced into the exhaust gas stream upstream of the intimate mixture.
